(19) United States
(12) Patent Application Publication
(10) Pub. No.: US 2025/0370864 A1
(43) Pub. Date: Dec. 4, 2025

(54) COMMAND ADDRESS PARITY CHECK USING A PARITY CHECK COMMAND

(71) Applicant: Micron Technology, Inc., Boise, ID (US)

(72) Inventor: Scott E. SCHAEFER, Boise, ID (US)

(21) Appl. No.: 19/098,818

(22) Filed: Apr. 2, 2025

Related U.S. Application Data
(60) Provisional application No. 63/653,470, filed on May 30, 2024.

(51) Int. Cl. G06F 11/10; G06F 9/30

(52) U.S. Cl. CPC G06F 11/1068; G06F 9/30189; G06F 11/1016

(57) ABSTRACT

In some implementations, a memory device may receive a command. The memory device may receive, subsequent to the command, a parity check command, where the parity check command includes a set of parity bits relating to the command. The memory device may perform a parity check for the command using the set of parity bits.

### CROSS-REFERENCE TO RELATED APPLICATION

This Patent application claims priority to U.S. Provisional Patent Application No. 63/653,470, filed on May 30, 2024, entitled “COMMAND ADDRESS PARITY CHECK USING A PARITY CHECK COMMAND,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to a command address parity check using a parity check command.

### BACKGROUND

Memory devices are widely used to store information for various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of a command address parity check using a parity check command.

FIGS. 2A-2B show a table indicating command definitions for memory.

FIG. 3 is a diagram of an example of a command address parity check using a parity check command.

FIG. 4 is a flowchart of an example method associated with a command address parity check using a parity check command.

### DETAILED DESCRIPTION

Command address (CA) parity checking may be used to verify the validity of information signaled to a memory device. However, memory devices (e.g., DRAM devices), such as those conforming to low power (LP) standards, may have limited provisions for effective error checking on command and address inputs. Some systems may aim for a greater than 99% diagnostic coverage (DC). For example, a high DC may be useful during a board bring-up phase (e.g., the initial phases of memory system operation), where systems may be subjected to rigorous debugging to ensure that all components are functioning correctly. Moreover, a high DC may be useful in applications in which low error rates are consequential, such as for autonomous vehicles. However, CA parity techniques may fail to provide the very high DC demanded by some systems, such as those that use stringent error detection for functional safety or debugging procedures. For example, CA parity techniques may achieve a DC in the range of 50% to 78.6%, depending on the implementation and the conditions, which is considered insufficient for applications that depend on a higher reliability of error detection.

Some implementations described herein relate to CA parity techniques that achieve significantly improved DC. In some implementations, a memory device may receive, from a host device, a parity check command (PCC) that indicates parity bits relating to a previous command received by the memory device. Using a separate parity check command enables the use of additional parity bits, thereby decreasing the number of command and address bits covered by each parity bit and increasing DC. Moreover, by using a separate parity check command, parity bits can be omitted from conventional commands, thereby increasing a robustness and/or a data capacity of the conventional commands.

In this way, techniques described herein enable CA parity with at least a 99% DC (e.g., 99.6% DC). This high DC facilitates reliable detection of errors, thereby improving host device and memory device communications. Accordingly, techniques described herein enable comprehensive validation and identification of errors with high precision during a memory system's board bring-up phase. Additionally, techniques described herein improve the performance of systems requiring elevated reliability, such as those used in autonomous vehicles.

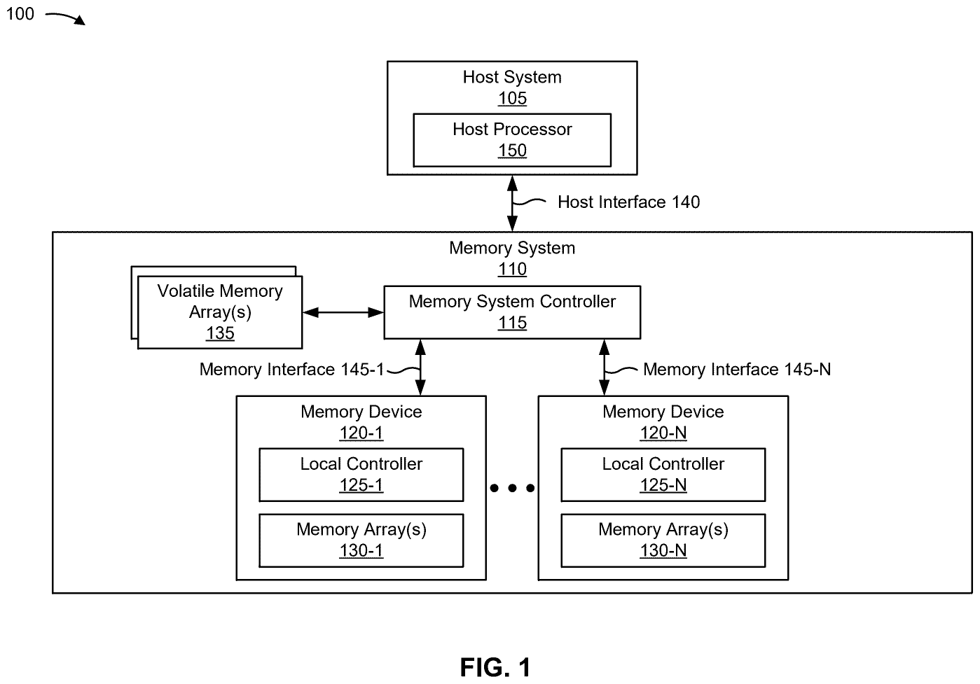

FIG. 1 is a diagram illustrating an example system 100 capable of a command address parity check using a parity check command. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N(where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

The components of the system 100 may exchange information with the memory system 110 using a plurality of channels. In some examples, the channels enable communications between the host system 105 and the memory system 110. Each channel may include one or more signal paths or transmission mediums (e.g., conductors) between terminals associated with the components of system 100. For example, a channel may include a first terminal including one or more pins or pads at the host system 105 and one or more pins or pads at the memory system 110. A pin or a pad may both be referred to herein as a “pin.” A pin may be an example of a conductive input or output point of a device of the system 100, and a pin may be configured to act as part of a channel. The memory system 110, or one or more of its components (e.g., a memory device 120), may include a plurality of pins associated with the plurality of channels.

In some cases, a pin of a terminal may be part of a signal path of the channel. Additional signal paths may be coupled with a terminal of a channel for routing signals within a component of the system 100. For example, the memory system 110 may include signal paths (e.g., signal paths internal to the memory system 110 or its components, such as internal to a memory device 120) that route a signal from a terminal of a channel to the various components of the memory system 110 (e.g., the memory system controller 115, a memory device 120, a local controller 125, or a memory array 130).

Channels (and associated signal paths and terminals) may be dedicated to communicating specific types of information. In some cases, a channel may be an aggregated channel and thus may include multiple individual channels. For example, a data channel may be x4 (e.g., including four signal paths), x8 (e.g., including eight signal paths), x16 (including sixteen signal paths), and so forth. Signals communicated over the channels may use DDR signaling. For example, some symbols of a signal may be registered on a rising edge of a clock signal and other symbols of the signal may be registered on a falling edge of the clock signal. Signals communicated over channels may use single data rate (SDR) signaling. For example, one symbol of the signal may be registered for each clock cycle.

In some cases, the channels may include one or more CA channels. The CA channels may be configured to communicate commands between the host system 105 and the memory system 110 including control information associated with the commands (e.g., address information). For example, the CA channel may include a read command with an address of the desired data. In some cases, the CA channels may be registered on a rising clock signal edge and/or a falling clock signal edge. In some cases, a CA channel may include any quantity of signal paths to decode address and command data (e.g., eight or nine signal paths). The memory system 110, or one of its components (e.g., a memory device 120), may include one or more (e.g., multiple) CA pins associated with the one or more CA channels.

In some cases, the channels may include one or more clock signal (CK) channels. The CK channels may be configured to communicate one or more common clock signals between the host system 105 and the memory system 110. Each clock signal may be configured to oscillate between a high state and a low state and coordinate the actions of the host system 105 and the memory system 110. In some cases, the clock signal may be a differential output (e.g., a CK_t signal and a CK_c signal) and the signal paths of the CK channels may be configured accordingly. In some cases, the clock signal may be single ended. A CK channel may include any quantity of signal paths. In some cases, the clock signal CK (e.g., a CK_t signal and a CK_c signal) may provide a timing reference for command and addressing operations for the memory system 110, or other system-wide operations for the memory system 110. The clock signal CK therefore may be variously referred to as a control clock signal CK, a command clock signal CK, or a system clock signal CK. The system clock signal CK may be generated by a system clock, which may include one or more hardware components (e.g., oscillators, crystals, logic gates, transistors, or the like). The memory system 110, or one of its components (e.g., a memory device 120), may include one or more (e.g., multiple) CK pins associated with the one or more CK channels.

In some cases, the channels may include one or more data (DQ) channels. The data channels may be configured to communicate data and/or control information between the host system 105 and the memory system 110. For example, the data channels may communicate information (e.g., bi-directional) to be written to the memory system 110 or information read from the memory system 110. The memory system 110, or one or more of its components (e.g., a memory device 120), may include one or more (e.g., multiple) data pins associated with the one or more data channels.

In some cases, the channels may include one or more other channels that may be dedicated to other purposes. These other channels may include any quantity of signal paths. The memory system 110, or one of its components (e.g., a memory device 120), may include one or more (e.g., multiple) pins associated with the one or more other channels. In some cases, the other channels may include one or more write clock signal (WCK) channels. While the ‘W’ in WCK may nominally stand for “write,” a write clock signal WCK (e.g., a WCK_t signal and a WCK_c signal) may provide a timing reference for access operations generally for the memory system 110 (e.g., a timing reference for both read and write operations). Accordingly, the write clock signal WCK may also be referred to as a data clock signal WCK. The WCK channels may be configured to communicate a common data clock signal between the host system 105 and the memory system 110. The data clock signal may be configured to coordinate an access operation (e.g., a write operation or read operation) of the host system 105 and the memory system 110. In some cases, the write clock signal may be a differential output (e.g., a WCK_t signal and a WCK_c signal) and the signal paths of the WCK channels may be configured accordingly. A WCK channel may include any quantity of signal paths. The data clock signal WCK may be generated by a data clock, which may include one or more hardware components (e.g., oscillators, crystals, logic gates, transistors, or the like).

In some implementations, one or more systems, devices, apparatuses, components, and/or controllers of FIG. 1 may be configured to receive a first set of command bits that indicates a command; receive, subsequent to the first set of command bits, a second set of command bits that indicates a parity check command, where the second set of command bits includes a set of parity bits relating to the first set of command bits; and perform a parity check for the first set of command bits using the set of parity bits.

In some implementations, one or more systems, devices, apparatuses, components, and/or controllers of FIG. 1 may be configured to receive a command; receive, subsequent to the command, a parity check command, where the parity check command includes a set of parity bits relating to the command; and perform a parity check for the command using the set of parity bits.

In some implementations, one or more systems, devices, apparatuses, components, and/or controllers of FIG. 1 may be configured to transmit a first set of command bits that indicates a command; and transmit, subsequent to the first set of command bits, a second set of command bits that indicates a parity check command, where the second set of command bits includes a set of parity bits relating to the first set of command bits. In some implementations, one or more systems, devices, apparatuses, components, and/or controllers of FIG. 1 may be configured to receive the first set of command bits and the second set of command bits; and perform a parity check for the first set of command bits using the set of parity bits.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

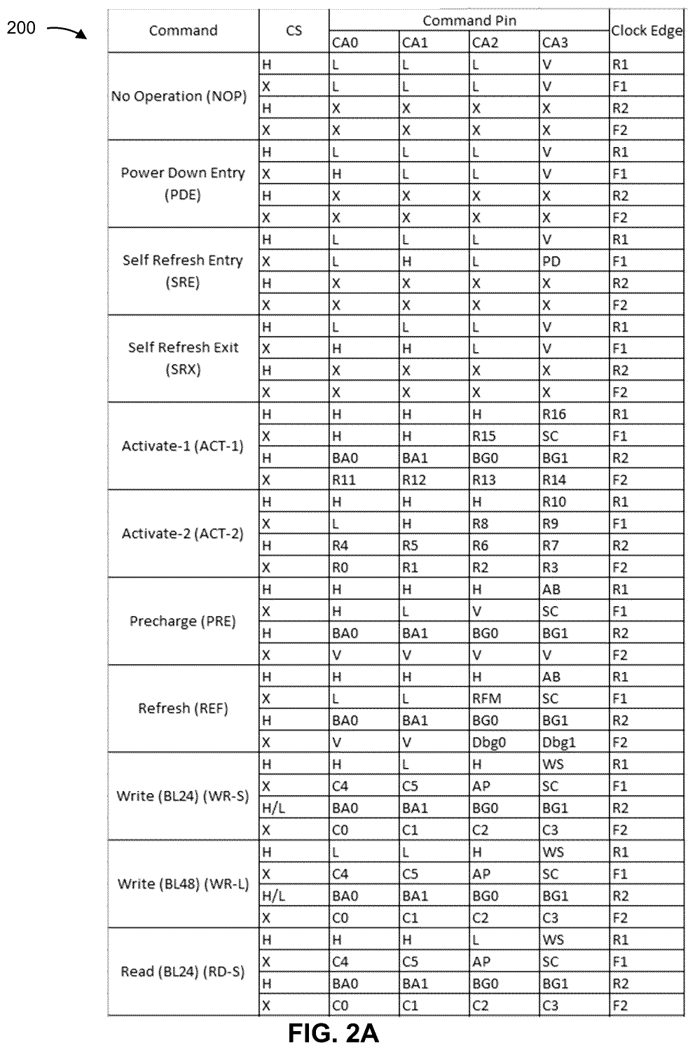

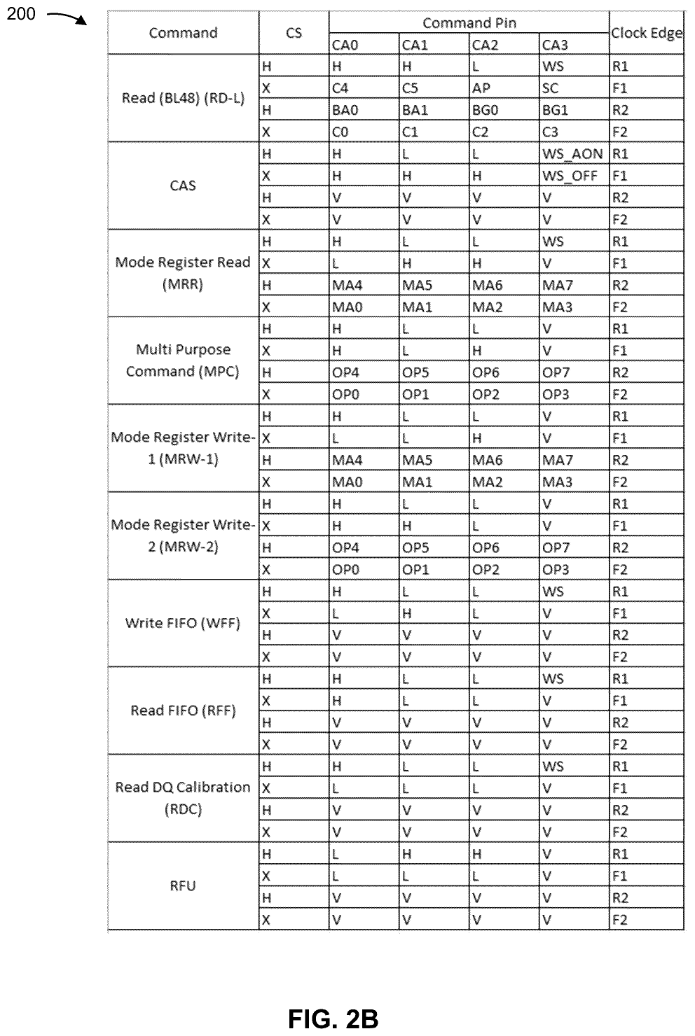

FIGS. 2A-2B show a table 200 indicating command definitions for memory. For example, the command definitions may relate to LP DDR commands for the memory system 110 or a component thereof. The table 200 indicates the signals for a chip select (CS) pin and four command pins (labeled CA0, CA1, CA2, and CA3), at a first rising edge (R1), a first falling edge (F1), a second rising edge (R2), and a second falling edge (F2) of a clock signal (e.g., DDR signaling), that can be used to indicate various commands. In table 200, “H” denotes a high signal and “L” denotes a low signal.

As shown, using DDR signaling, each command definition at the command pins may be represented by 16 bits of data. In some implementations, a command definition may be represented by a different number of bits. A command definition for a command may indicate one or more available bits (e.g., reserved for future use (RFU) bits), which are shown as a “V” or an “X” in table 200. As further shown, the command definitions may include a definition for an RFU command. The definition for the RFU command may indicate a plurality of RFU bits (e.g., 10 RFU bits as shown) for the RFU command.

As indicated above, FIGS. 2A-2B are provided as an example. Other examples may differ from what is described with regard to FIGS. 2A-2B.

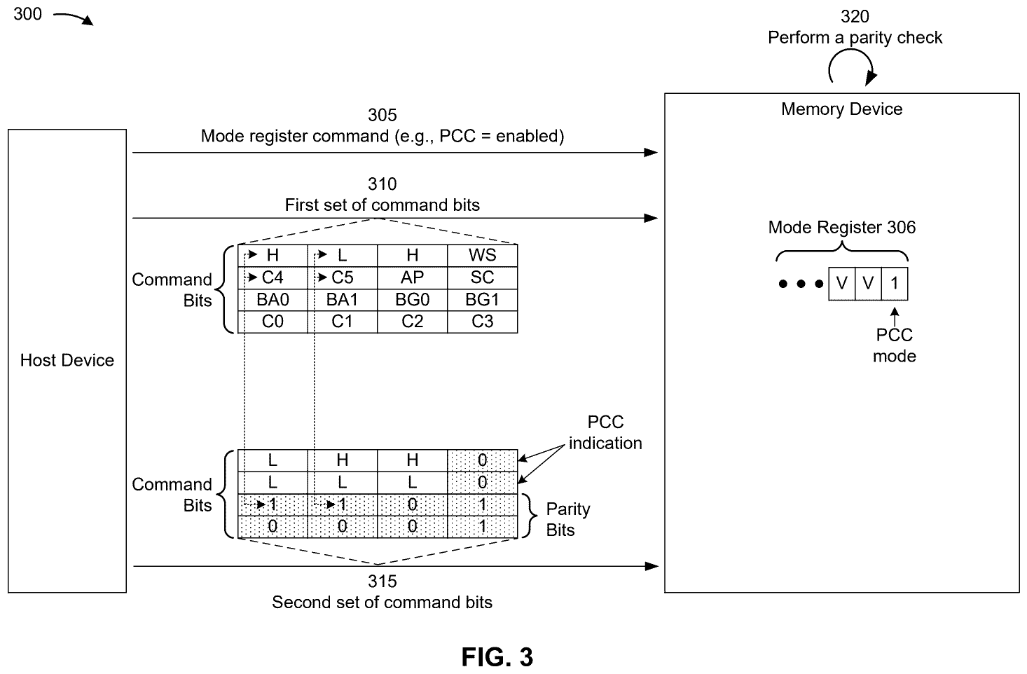

FIG. 3 is a diagram of an example 300 of a command address parity check using a parity check command. Various operations described in connection with FIG. 3 may be performed by a memory device, such as the memory system 110 and/or one or more components of the memory system 110, including the memory system controller 115, one or more memory devices 120, and/or one or more local controllers 125. As described herein, the memory device may have a plurality of pins, including a set of command pins (also referred to herein as “CA pins”) used for communicating commands between a host device (e.g., host system 105 or host processor 150) and the memory device.

As shown by reference number 305, the host device may transmit, and the memory device may receive, a mode register command for a mode register 306 of the memory device. The mode register command may configure (e.g., set) a parameter in the mode register 306 to enable a parity check command mode for the memory device. When the parity check command mode is enabled, the host device and the memory device may compute parity information on commands (e.g., mission commands) issued to the memory device. Alternatively, the mode register command may configure the parameter in the mode register 306 to disable the parity check command mode for the memory device. When the parity check command mode is disabled, the host device and the memory device are not required to compute parity information on commands (e.g., mission commands) issued to the memory device. In this way, the mode register 306 of the memory device may include an indication of whether the parity check command mode is enabled or disabled.

As shown by reference number 310, the host device may transmit, and the memory device may receive (e.g., by DDR signaling), a first set of command bits. For example, the memory device may receive the first set of command bits via the set of command pins (e.g., the memory device may receive signaling indicating the command bits via the set of command pins). The first set of command bits may indicate a command, such as one of the commands defined in table 200. For example, the command may be a read command or a write command, among other examples. Moreover, the first set of command bits may also indicate control information (e.g., address information) associated with the command. For example, the first set of command bits may be represented as a data matrix indicating the command and the address information. As an example, the first set of command bits may indicate the command and the address information using 16 bits. In some implementations, the command may be randomly issued (e.g., the host device may randomly select the command to issue to the memory device), such as in connection with a debugging procedure.

As shown by reference number 315, subsequent to the first set of command bits, the host device may transmit, and the memory device may receive (e.g., by DDR signaling), a second set of command bits. For example, the memory device may receive the second set of command bits via the set of command pins (e.g., the memory device may receive signaling indicating the command bits via the set of command pins). The second set of command bits may indicate a parity check command. Moreover, the second set of command bits (e.g., the parity check command) may include a set of parity bits relating to the first set of command bits (e.g., relating to the previous command). The parity check command may indicate that the set of parity bits are to be used for a parity check relating to the previous command indicated by the first set of command bits (e.g., provided that the parity check command mode is enabled in the mode register 306). Accordingly, the parity check command may immediately follow the previous command without an intervening command between the previous command and the parity check command. However, there may be other intervening non-command data between the previous command and the parity check command, such as padding bits, command delimiter bits, or the like. In cases when the parity check command does not follow another command, the use of the parity check command may be considered to be invalid and having no defined operation (e.g., unless special actions are taken).

In some implementations, the second set of command bits may indicate an RFU command (e.g., as shown in table 200), and the parity check command may be indicated in the RFU command. As described herein, a definition of the RFU command (e.g., in accordance with table 200) may indicate a plurality of RFU bits (shown with shading) for the RFU command. One or more (e.g., two) first bits of the RFU bits may be repurposed to indicate that the second set of command bits includes the parity check command (e.g., the second set of command bits may include one or more bits set to values indicating that the second set of command bits is the parity check command). For example, as shown, the one or more first bits may include a pair of bits set to a 0, 0 value to indicate that the RFU command is repurposed as the parity check command. In this way, the RFU command can also be repurposed for three additional commands other than the parity check command (e.g., using the values 0, 1; 1, 0; and 1, 1 for the pair of bits). Multiple second bits of the RFU bits may be repurposed as the set of parity bits.

Each bit of the set of parity bits may relate to a respective portion of the first set of command bits. For example, the set of parity bits may include eight bits, and each of the eight bits may relate to a respective group of two bits in the first set of command bits (e.g., the first set of command bits may have a total of 16 bits). As an example, the eight parity bits may cover two bits of command data, of the previous command, per parity bit. The mapping of parity bits to bits of command data shown in FIG. 3 is provided as an example, and other mappings may be used. In some implementations, the previous command and the parity check command may be issued to the memory device in connection with a debugging procedure.

The parity check command may cause the memory device to perform a parity check, but the parity check command may not indicate any other operation that is to be performed by the memory device. Accordingly, as shown by reference number 320, the memory device may perform a parity check for the first set of command bits using the set of parity bits. For example, the memory device may compute a parity value for a set of bits (e.g., two bits) of the first set of command bits (e.g., using an XOR operation on the set of bits), and the memory device may perform the parity check by comparing the parity value to a value of a parity bit. The memory device may perform the parity check in connection with executing a memory operation in accordance with the previous command. For example, the memory device may execute the memory operation provided that the parity check succeeds (e.g., the computed parity value matches the parity bit). Alternatively, if the parity check fails, the memory device may refrain from executing the memory operation, may register an indication of the failed parity check, and/or may transmit an indication of the failed parity check to the host device.

In this way, techniques described herein enable CA parity checks through the use of a separate parity check command that provides additional parity bits, thereby decreasing the number of command bits covered by each parity bit and increasing DC. For example, techniques described herein enable CA parity with at least a 99% DC (e.g., a 99.6% DC). Accordingly, techniques described herein achieve highly reliable error detection for the memory device.

As indicated above, FIG. 3 is provided as an example. Other examples may differ from what is described with regard to FIG. 3.

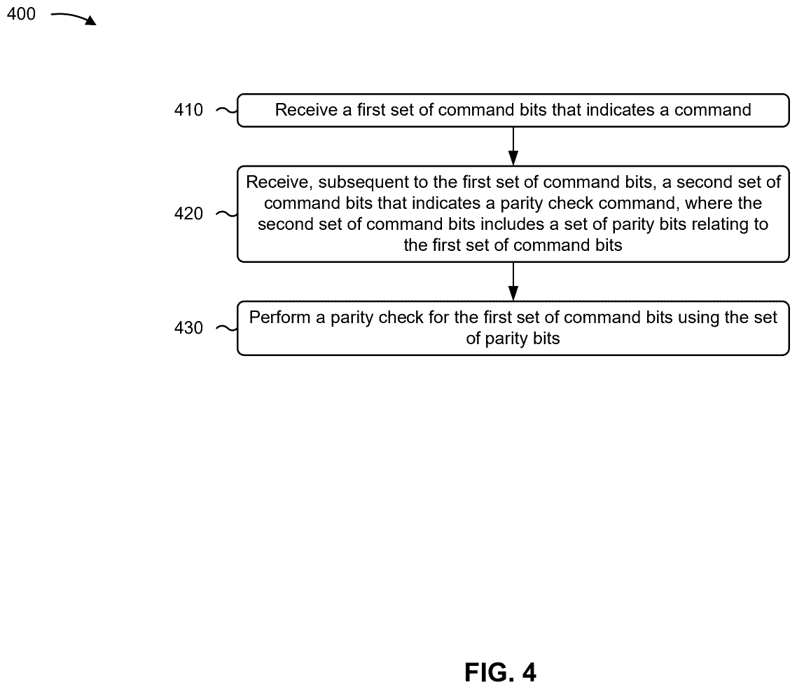

FIG. 4 is a flowchart of an example method 400 associated with a command address parity check using a parity check command. In some implementations, a memory device (e.g., the memory system 110) may perform or may be configured to perform the method 400. In some implementations, another device or a group of devices separate from or including the memory device may perform or may be configured to perform the method 400. Additionally, or alternatively, one or more components of the memory device (e.g., the memory system controller 115, the memory device 120, the local controller 125, or the memory array 130) may perform or may be configured to perform the method 400. Thus, means for performing the method 400 may include the memory device and/or one or more components of the memory device. Additionally, or alternatively, a non-transitory computer-readable medium may store one or more instructions that, when executed by the memory device (e.g., the memory system controller 115 and/or the local controller 125), cause the memory device to perform the method 400.

As shown in FIG. 4, the method 400 may include receiving a first set of command bits that indicates a command (block 410). As further shown in FIG. 4, the method 400 may include receiving, subsequent to the first set of command bits, a second set of command bits that indicates a parity check command, where the second set of command bits includes a set of parity bits relating to the first set of command bits (block 420). As further shown in FIG. 4, the method 400 may include performing a parity check for the first set of command bits using the set of parity bits (block 430).

The method 400 may include additional aspects, such as any single aspect or any combination of aspects described below and/or described in connection with one or more other methods or operations described elsewhere herein.

In a first aspect, the first set of command bits indicates the command and address information.

In a second aspect, alone or in combination with the first aspect, the second set of command bits includes one or more bits set to values indicating that the second set of command bits includes the parity check command.

In a third aspect, alone or in combination with one or more of the first and second aspects, the second set of command bits indicates an RFU command, and the parity check command is indicated in the RFU command.

In a fourth aspect, alone or in combination with one or more of the first through third aspects, a definition of the RFU command indicates a plurality of RFU bits for the RFU command, and one or more first bits of the RFU bits are repurposed to indicate that the second set of command bits includes the parity check command, and multiple second bits of the RFU bits are repurposed as the set of parity bits.

In a fifth aspect, alone or in combination with one or more of the first through fourth aspects, each bit of the set of parity bits relates to a respective portion of the first set of command bits.

In a sixth aspect, alone or in combination with one or more of the first through fifth aspects, the set of parity bits consists of eight bits, and each of the eight bits relates to a respective group of two bits in the first set of command bits.

In a seventh aspect, alone or in combination with one or more of the first through sixth aspects, the parity check command immediately follows the command without an intervening command between the command and the parity check command.

In an eighth aspect, alone or in combination with one or more of the first through seventh aspects, the method 400 includes receiving a mode register command, for a mode register of the memory device, that configures whether a parity check command mode for the memory device is enabled or disabled.

In a ninth aspect, alone or in combination with one or more of the first through eighth aspects, receiving the first set of command bits and receiving the second set of command bits includes receiving the first set of command bits and receiving the second set of command bits by DDR signaling.

In a tenth aspect, alone or in combination with one or more of the first through ninth aspects, the memory device includes DRAM.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

In some implementations, a memory device includes one or more components configured to: receive a first set of command bits that indicates a command; receive, subsequent to the first set of command bits, a second set of command bits that indicates a parity check command, where the second set of command bits includes a set of parity bits relating to the first set of command bits; and perform a parity check for the first set of command bits using the set of parity bits.

In some implementations, a method includes receiving, by a memory device from a host device, a command; receiving, by the memory device from the host device and subsequent to the command, a parity check command, where the parity check command includes a set of parity bits relating to the command; and performing a parity check for the command using the set of parity bits.

In some implementations, a system includes a host device configured to: transmit a first set of command bits that indicates a command; and transmit, subsequent to the first set of command bits, a second set of command bits that indicates a parity check command, where the second set of command bits includes a set of parity bits relating to the first set of command bits; and a memory device configured to: receive the first set of command bits and the second set of command bits; and perform a parity check for the first set of command bits using the set of parity bits.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
receive a first set of command bits that indicates a command;
receive, subsequent to the first set of command bits, a second set of command bits that indicates a parity check command,
wherein the second set of command bits includes a set of parity bits relating to the first set of command bits; and
perform a parity check for the first set of command bits using the set of parity bits.

2. The memory device of claim 1, wherein the first set of command bits indicates the command and address information.

3. The memory device of claim 1, wherein the second set of command bits includes one or more bits set to values indicating that the second set of command bits includes the parity check command.

4. The memory device of claim 1, wherein the second set of command bits indicates a reserved for future use (RFU) command, and the parity check command is indicated in the RFU command.

5. The memory device of claim 4, wherein a definition of the RFU command indicates a plurality of RFU bits for the RFU command, and
wherein one or more first bits of the RFU bits are repurposed to indicate that the second set of command bits includes the parity check command, and multiple second bits of the RFU bits are repurposed as the set of parity bits.

6. The memory device of claim 1, wherein each bit of the set of parity bits relates to a respective portion of the first set of command bits.

7. The memory device of claim 1, wherein the set of parity bits consists of eight bits, and
wherein each of the eight bits relates to a respective group of two bits in the first set of command bits.

8. The memory device of claim 1, wherein the parity check command immediately follows the command without an intervening command between the command and the parity check command.

9. The memory device of claim 1, wherein the one or more components are further configured to:
receive a mode register command, for a mode register of the memory device, that configures whether a parity check command mode for the memory device is enabled or disabled.

10. The memory device of claim 1, wherein the one or more components, to receive the first set of command bits and to receive the second set of command bits, are configured to receive the first set of command bits and to receive the second set of command bits by double data rate (DDR) signaling.

11. The memory device of claim 1, wherein the memory device comprises dynamic random-access memory (DRAM).

12. A method, comprising:
receiving, by a memory device from a host device, a command;
receiving, by the memory device from the host device and subsequent to the command, a parity check command,
wherein the parity check command includes a set of parity bits relating to the command; and
performing a parity check for the command using the set of parity bits.

13. The method of claim 12, wherein the parity check command is indicated in a reserved for future use (RFU) command.

14. The method of claim 13, wherein a definition of the RFU command indicates a plurality of RFU bits for the RFU command, and
wherein one or more first bits of the RFU bits are repurposed to indicate that the RFU command includes the parity check command, and multiple second bits of the RFU bits are repurposed as the set of parity bits.

15. The method of claim 12, wherein each bit of the set of parity bits relates to a respective portion of command bits for the command.

16. The method of claim 12, wherein the parity check command immediately follows the command without an intervening command between the command and the parity check command.

17. The method of claim 12, further comprising:
receiving a mode register command, for a mode register of the memory device, that configures whether a parity check command mode for the memory device is enabled or disabled.

18. The method of claim 12, wherein the command and the parity check command are received in connection with a debugging procedure.

19. A system, comprising:
a host device configured to:
transmit a first set of command bits that indicates a command; and
transmit, subsequent to the first set of command bits, a second set of command bits that indicates a parity check command,
wherein the second set of command bits includes a set of parity bits relating to the first set of command bits; and
a memory device configured to:
receive the first set of command bits and the second set of command bits; and
perform a parity check for the first set of command bits using the set of parity bits.

20. The system of claim 19, wherein the parity check command is indicated in a reserved for future use (RFU) command.

21. The system of claim 20, wherein a definition of the RFU command indicates a plurality of RFU bits for the RFU command, and
wherein one or more first bits of the RFU bits are repurposed to indicate that the second set of command bits includes the parity check command, and multiple second bits of the RFU bits are repurposed as the set of parity bits.

22. The system of claim 19, wherein each bit of the set of parity bits relates to a respective portion of the first set of command bits.

23. The system of claim 19, wherein the parity check command immediately follows the command without an intervening command between the command and the parity check command.

24. The system of claim 19, wherein the host device is further configured to:
transmit a mode register command, for a mode register of the memory device, that configures whether a parity check command mode for the memory device is enabled or disabled.

25. The system of claim 19, wherein the memory device is further configured to:
receive a mode register command, for a mode register of the memory device, that configures whether a parity check command mode for the memory device is enabled or disabled.
